(19) United States
(12) Patent Application Publication
(10) Pub. No.: US 2008/0011267 A1
(43) Pub. Date: Jan. 17, 2008

(54) Rotary piston engine

(76) Inventor: Masami Sakita, San Francisco, CA (US)

Correspondence Address: MASAMI SAKITA, P.O. BOX 61089, PALO ALTO, CA, 94306-1089, US

(21) Appl. No.: 11/485,623

(22) Filed: Jul. 13, 2006

(51) Int. Cl. F02B 53/00

(52) U.S. Cl. 123/241

(57) ABSTRACT

An internal combustion engine including a working chamber assembly housing, intake and exhaust ports, a pair of piston assemblies each of which assemblies includes at least one pair of diametrically opposed pistons within the working chamber assembly housing rotatable about a rotational axis of said piston assemblies, means for interconnecting said first and second piston assemblies for variable speed rotation in the same direction during recurrent periods of rotation, wherein the piston having a piston head and a piston vessel, the piston head of one piston assembly received by the piston vessel of the other piton assembly to form a working chamber. The connecting means includes a pair of internal gears, a plurality of planetary gears and means for transmitting variable rotation, a main gear set, and a pair of auxiliary means that is connected to the piston assemblies.

### FIELD OF THE INVENTION

This invention relates generally to rotary piston engines and in particular to rotary piston engines that include first- and second-piston assemblies that are interconnected for alternate variable-speed rotation whereby pistons of the slower piston assembly comprise trailing pistons during the power and intake phases of the engine operating cycle.

### BACKGROUND OF THE INVENTION

In the engine known as a cat-and-mouse type rotary engine that uses two sets of piston assemblies each having plurality of diagonally opposed pistons, and divide a toroidal working chamber into a plurality of subchambers, the working chamber has crevices that extend circumferentially between the engine's housing and piston assemblies and/or between piston assemblies. In some of the proposed engines, these crevices are sealed by seal means called a chamber ring or a packing ring, which was first proposed by Weed in U.S. Pat. No. 1,328,410, and later modified by various inventors. The engine of this type with or without these seal means, however, has never been successfully built or tested as far as the present inventor knows. To ensure proper operation of the engine, the crevices and/or seal means must be well cooled and lubricated. Thus a cooling and lubrication means that is able to circulate a large enough amount of cooling liquid to cool the working chamber and lubricate the crevices and/or seal means is an absolute necessity for such an engine. Alternatively, conception of a new working chamber design that does not have the crevices and/or does not require the unproven seal means technology is a way to solve the possible problem altogether.

In the engine of this type, having an effective interconnecting means of the two piston assemblies that has to deal with a large amount of rotational force is extremely important. Connecting means that have been proposed in the past include the use of a sun-planetary gear and crank mechanism by Kauertz (U.S. Pat. No. 3,144, 007) and a modified sum-planetary gear and crank mechanism by Bakhtine (U.S. Pat. No. 6,305,345), and a gear module that uses noncircular gear sets by the present inventor Sakita (U.S. Pat. No. 6,457,451).

In the connecting means proposed by Kauertz, the inner piston shaft is affixed to the main piston assembly, and functions as the output shaft. The rotational speed of the outer coaxial piston shaft to which the other piston assembly is connected is controlled by a unique sun-planetary gear and crank mechanism and rotates around the rotational axis of the inner piston shaft with varying speeds. The connecting means by Bakhtine includes the sun-planetary gear crank mechanism with a plurality of crank mechanisms in each side of engine's working chamber and an inner shaft that functions as the output shaft. The connecting means by Bkhtine is an improvement over the connecting means by Kauertz. His connecting means, however, does not solve the problem in a satisfactory manner.

In case of the gear module that uses the noncircular gears proposed by Sakita, he later found that the gear module requires the use of circular gears of a large mass and a plurality of circular pinions and the noncircular gear sets to cope with a large amount of rotational force, making the connecting means rather large and its design somewhat awkward.

The rotary piston engine of this type has room for improvements especially in these critical areas.

### OBJECTS OF THE INVENTION

An object of this invention is the provision of a cat-and-mouse type rotary engine that has a plurality of working chambers equipped with seal means of a proven technology.

An object of this invention is the provision of a cat-and-mouse type rotary engine that interconnects the two piston assemblies through a connecting means without involving the output shaft.

An object of this invention is the provision of a cat-and-mouse type rotary engine that is equipped with a cooling means that enables circulation of a large enough amount of cooling liquid through the piston assembly cavities for cooling the piston assembly.

### SUMMARY OF THE INVENTION

The preferred embodiment of the present invention includes a rotary piston engine including a working chamber assembly that includes a plurality of working chambers, enclosed in a stationary working chamber assembly housing, and a connecting means enclosed in a stationary connecting means housing. The working chambers are formed by a pair of piston assemblies that are rotatable about a common axis, and in operation, the piston assemblies rotate in the same direction. The piston assembly includes at least one pair of diametrically opposed pistons attached to a piston hub, which in turn is affixed to either the outer or inner coaxial shaft.

The piston comprises a piston head and a piston vessel. The piston head has a circular piston surface with a center that forms a circular trajectory around the rotational axis of the coaxial piston shafts as the piston rotates. The internal space of the piston vessel has a circular lateral cross section with a slightly larger diameter than that of the piston surface of the piston head, and the center of the circular cross section of the internal space shares the circular trajectory that is formed while in rotational movement with the center of the piston surface. The piston head has a convex outer surface on which a piston ring is laid in a piston ring groove. The piston vessel of the leading piston slidably receives the piston head of the trailing piston, and the piston vessel and the piston head together form a working chamber. Each piston assembly alternately rotates with a faster and slower speeds in such a manner that the trailing pistons rotate at a slower speed than the leading pistons during the power and intake phases of engine operation, and the trailing pistons rotate at a faster speed than the leading pistons during the compression and exhaust phases of engine operation.

The working chamber assembly housing has an exhaust port, an intake port, and a pair of ports for pumping in cold air to the internal space of the working chamber assembly housing, and a pair of ports for taking out hot air from the same internal space. The piston has a port for intake and exhaust activity. The piston's intake/exhaust port is equipped with a port ring that is laid in a groove surrounding the port, and the ring is pressed against the internal wall of the engine's working chamber assembly housing while the piston travels. The intake port communicates with the internal space of the piston vessel while the piston's intake/exhaust port travels next to the intake port of the working chamber assembly. Similarly, the exhaust port communicates with the internal space of the piston vessel while the piston's intake/exhaust port travels next to the exhaust port of the working chamber assembly.

The connecting means includes main transmission means, a pair of auxiliary transmission means, and a pair of internal gears affixed to the internal wall of the connecting means housing. The main transmission means comprises a main gear set and generally identical two parts, one in each side of the main gear set. Each part of the main transmission means comprises a plurality of planetary gear and crank mechanisms, each of which comprises a planetary gear, a connecting rod, a piston pin, and a crank pin. One auxiliary transmission means is affixed to the outer piston shaft, and the other auxiliary transmission means is affixed to the inner piston shaft.

The working chamber assembly and the connecting means are cooled and lubricated by cooling and lubrication means. The oil delivery system includes oil bores, an oil outlet, oil gutters, an oil pump, and an oil pan. Oil is pumped into the working chamber assembly through an oil bore, which extends along the rotational axis of the inner piston shaft. The cooling and lubrication oil carried by the bore is diverted into radially extending bores, and into the inner cavities of the piston assemblies. The oil that is used to cool the piston assemblies shoots out of these piston assemblies from the oil outlet to the main oil gutter that extends along an imaginary line that is made up of outer most points of the internal wall of the working chamber assembly housing, and recycled back to the oil pan and oil pump.

### BRIEF DESCRIPTION OF THE DRAWINGS

The above and other objects and advantages of the invention will be better understood from the following description when considered with the accompanying drawings. It here will be understood that the drawings are for purposes of illustration only and not by way of limitation of the invention. In the drawings, like reference characters refer to the same parts in the several views:

FIG. 1 is a 3-D view of the rotary piston engine of the preferred embodiment of the present invention;

FIG. 2 is a cross-sectional view of the working chamber assembly and working chamber assembly housing of the rotary piston engine of the preferred embodiment of the present invention;

FIG. 3 is a 3-D view of the piston;

FIG. 4 is a cross-sectional view of a piston assembly of an 8-piston rotary engine;

FIG. 5 is a cross-sectional view of the working chamber assembly of the 8-piston rotary engine;

FIG. 6 is a cross-sectional view of the working chamber and a swirl created by the intake port;

FIG. 7 is an expanded view of the cross sectional view of the intake port and the fuel injector nozzle;

FIG. 8 is an expanded cross-sectional view of the intake port taken along A-A of FIG. 7 taken at the time while the piston is passing next to the intake port;

FIG. 9 shows the internal gear-planetary gear and crank mechanism on the A part of the main transmission means;

FIG. 10 shows the internal gear-planetary gear and crank mechanism on the B part of the main transmission means;

FIG. 11 is a schematic diagram showing superimposed the planetary gear and crank mechanisms of the A and B parts;

FIG. 12 is a side view of the connecting means showing only two front planetary gear and crank mechanisms in each part;

FIG. 13 is a diagram showing rotational speed variation of the piston assemblies in the rotary piston engine embodying the present invention;

FIG. 14 is a cross-sectional view of the working chamber with emphasis on the engine's cooling and lubrication means, and the wiring system of the spark ignition engine version of the rotary piston engine embodying the present invention;

FIG. 15 is a cross sectional view of an alternative embodiment of the piston assembly;

FIG. 16 is a cross sectional view of the alternative embodiment of the piston assembly taken along C-C of FIG. 15; FIG. 17 is an alternative embodiment of the connecting means;

FIG. 18 is a schematic diagram showing a noncircular gear set used in the connecting means of the alternative embodiment;

FIG. 19 is a diagram showing rotational speed variation of the piston assemblies in the rotary piston engine that uses the connecting means of the alternative embodiment;

FIG. 20 is a longitudinal cross-sectional view of an alternative embodiment of the working chamber assembly with a cooling and lubrication oil means; and

FIG. 21 is a lateral cross-sectional view of the alternative embodiment of the working chamber assembly with a cooling and lubrication oil means.

### DETAILED DESCRIPTION OF THE INVENTION

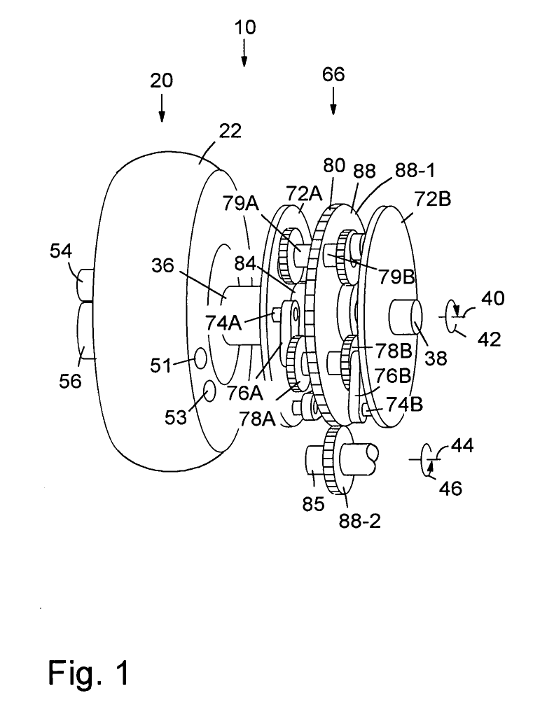

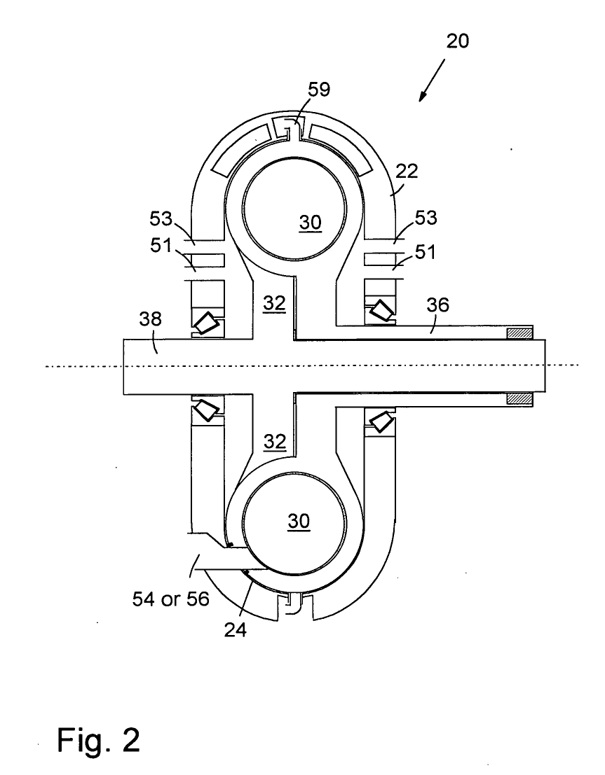

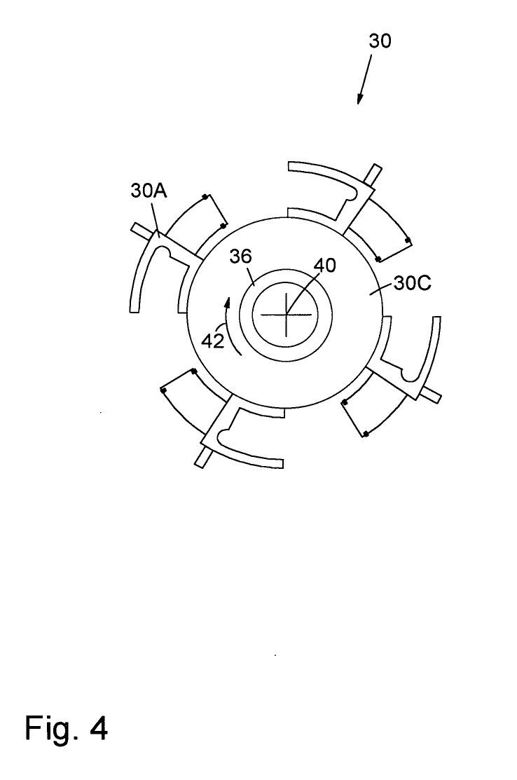

Reference now is made to FIGS. 1 through 5 of the drawings wherein the preferred embodiment of an engine 10 is shown to include a working chamber assembly 20 having a pair of piston assemblies 30 and 32 enclosed in a stationary working chamber assembly housing 22, and a connecting means 66 enclosed in a stationary connecting means housing (not shown).

The piston assembly 30 includes at least one pair of diametrically opposed pistons 30A attached to piston hub 30C, and the piston assembly 32 includes at least one pair of diametrically opposed pistons 32A attached to a piston hub 32C. The piston hub 30C is affixed to a tubular piston shaft 36, and the piston hub 32C is affixed to an inner shaft 38, wherein the inner piston shaft 38 is rotatably mounted in a tubular shaft 36. The number of pistons per piston assembly may be two or a multiple of four. The piston assemblies 30 and 32 are rotatable about a common axis 40 and, in operation, rotate in the same direction as indicated by arrows 42. Each piston assembly alternately rotates with faster and slower speeds in such a manner that the trailing pistons rotate at a slower speed than the leading pistons during the power and intake phases of the working chamber operation, and the trailing pistons rotate at a faster speed than the leading pistons during the compression and exhaust phases of the working chamber operation.

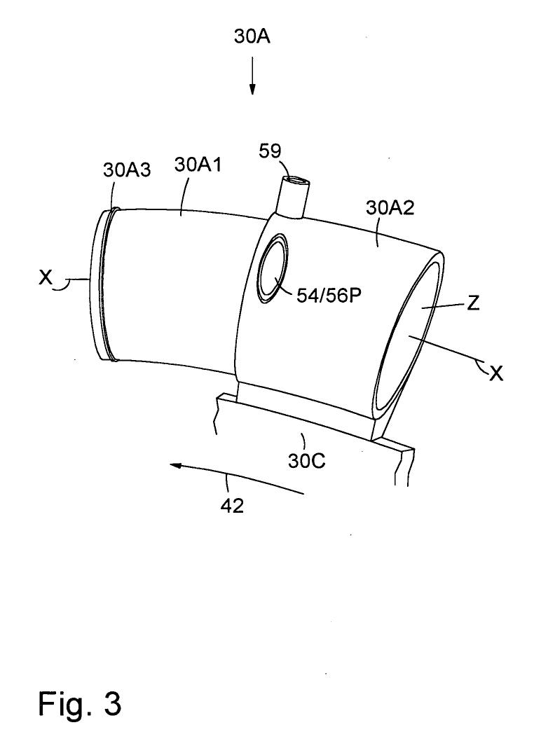

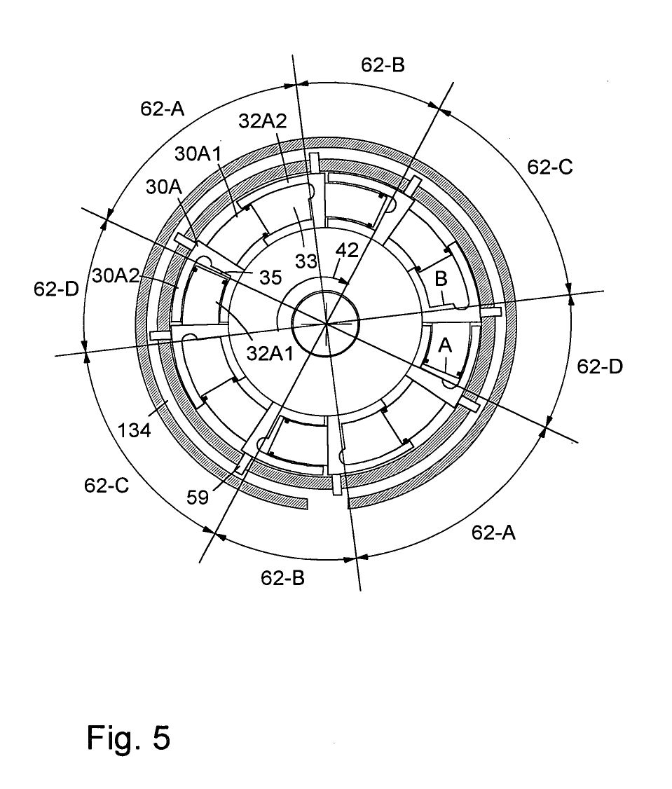

Referring to FIGS. 3, 4 and 5 of the drawings, the piston 30A, which is generally identical to the piston 32A, comprises a piston head 30A1 and a piston vessel 30A2. The piston head 30A1 has a circular piston surface with a center that forms a circular trajectory X-X around the rotational axis 40 of the piston shafts 36 and 38 as the piston 30A rotates. The internal space of the piston vessel 30A2 has a circular lateral cross section Z (relative to the piston's direction of travel) with a slightly larger diameter than that of the piston surface of the piston head 30A1, and the center of the lateral circular cross section Z of the piston vessel 30A2 shares the circular trajectory X-X with the piston head 32A1 as the piston travels. As is shown in FIG. 5, the piston vessel 32A2 of the leading piston 32A slidably receives the piston head 30A1 of the trailing piston 30A, and the piston vessel 32A2 and the piston head 30A1 together form a working chamber 33. Similarly, the piston vessel 30A2 of the leading piston 30A slidably receives the piston head 32A1 of the trailing piston 32A, and the piston vessel 30A2 and the piston head 32A1 together form a working chamber 35. A piston ring 30A3 and a piston ring 32A3 seal the working chamber 33 and the working chamber 35, respectively.

The working chamber assembly housing 22 has an intake port 54, an exhaust port 56, a pair of ports 51 for pumping in cold air to the internal space of the working chamber assembly housing, and another pair of ports 53 for taking out hot air in the same internal space. The piston 30A (and piston 32A) has an intake/exhaust port 54/56P that is used for both intake and exhaust activity. The intake/exhaust port 54/56P is equipped with a port ring that is laid in a groove surrounding the port 54/56P, wherein the port ring is always pressed against the internal wall 24 of the working chamber assembly housing 22 by force generated by an embedded spring. The intake port 54 communicates with the inner cavity of the piston vessel 30A2 (or 32A2) while the intake/exhaust port 54/56P of the piston 30A (or 32A) travels next to the intake port 54 of the working chamber assembly housing. Similarly, the exhaust port 56 communicates with the inner cavity of the piston vessel 30A2 (or 32A2) while the intake/exhaust port 54/56P of the piston 30A (or 32A) travels next to the exhaust port 56 of the working chamber assembly housing.

With an eight-piston engine as illustrated in FIG. 5 of the drawings, the working chamber assembly housing 22 includes eight working chambers. The combustion phase of engine operation occurs during the angular movement of the leading piston's intake/exhaust port is within the segment shown by a double arrow 62-A. The exhaust phase of the engine occurs during the angular movement of the leading piston's intake/exhaust port is within the segment shown by a double arrow 62-B. The intake phase occurs during the angular movement of the leading piston's intake/exhaust port is within the segment shown by a double arrow 64-C. And, the compression phase occurs during the angular movement of the leading piston's intake/exhaust port is within the segment shown by a double arrow 64-D. If the leading piston's intake/expansion port is within the segments 64-A or 62-C, the leading piston assembly is said to be in the active phase, and if the leading piston's intake/exhaust port is within the segments 60-B or 62-D, the leading piston assembly is said to be in the non-active phase. FIG. 5 shows the time point at which the piston assembly 30 that includes pistons 30A has just finished the non-active phase and is just about to start the active phase, and piston assembly 32 that includes pistons 32A has just finished the active phase and is just about to start the non-active phase. FIG. 5 indicates that in an eight-piston engine, at any time point, a pair of the four operating phases (namely, intake, compression, combustion, and exhaust phases) occur in the working chamber assembly simultaneously, and each working chamber experiences two full operating cycles of the four successive engine phases in one full rotation in the whole working chamber.

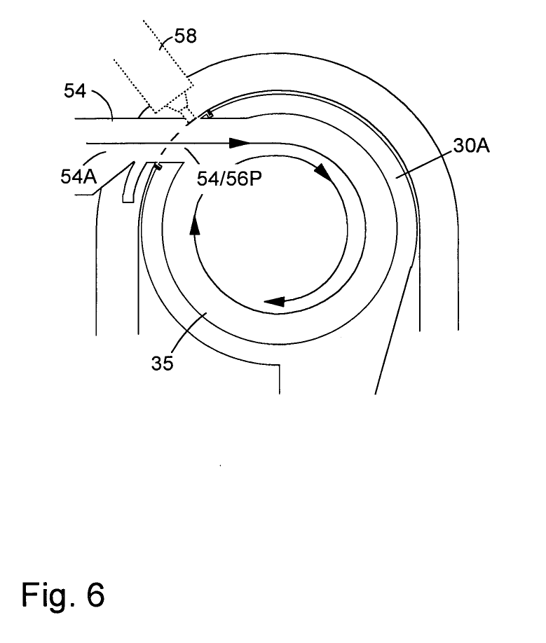

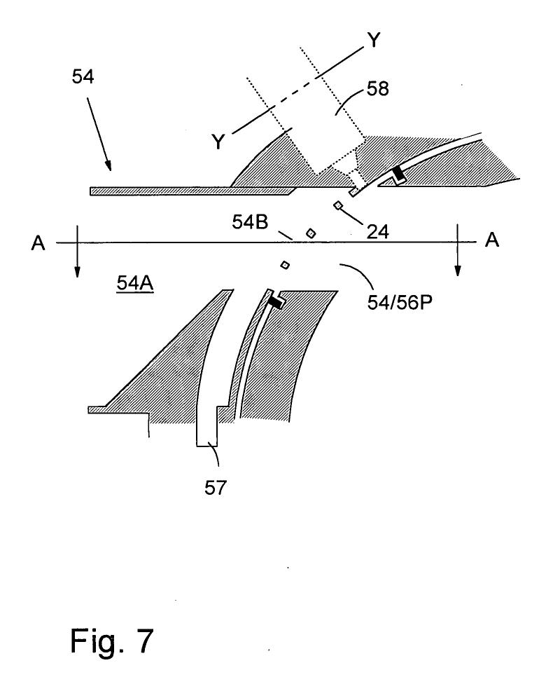

Reference is now made to FIGS. 6 through 8 of the drawings wherein diagrams illustrating the intake port 54 of the working chamber assembly are shown. The intake port 54, which is designed to be able to create a swirl of air (or air and fuel mix) as shown in FIG. 6, includes an outer opening 54A and an inner opening 54B that comprises a plurality of openings on the internal wall 24 of the working chamber assembly housing 22. The inner opening 54B faces the trajectory of the piston's intake/exhaust port 54/56P, and air or fuel mix is blown into the engine's working chamber 35 (or 33) from the intake port 54 of the working chamber assembly while the piston's intake/exhaust port travels next to the intake port of the working chamber assembly. Lubrication and cooling oil seeped into the internal space of the intake port 54 is recycled to an oil pan (not shown) through the oil gutter 57.

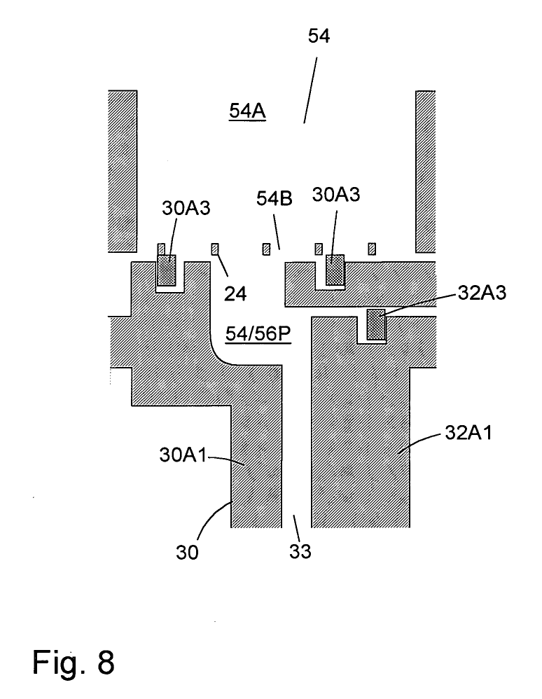

As is shown in FIG. 8, the air or the air fuel mixture is taken into the working chamber 33 through the piston's intake exhaust port 54/56P. The exhaust port 56 of the working chamber assembly installed longitudinally next to the intake port 54 relative to the piston's travel is generally identical in design to the intake port except that the exhaust port 56 is used for exhausting used fuel mixture. It is possible to have separate piston ports for the intake and exhaust activities: one port for the exhaust activity on one side of the piston and the other port for the intake activity on the other side of the piston. In such a design, separate intake and exhaust ports must be installed on the working chamber assembly housing in the opposite sides of the working chambers. In a fuel-injected engine, a fuel injector 58 is mounted generally in the segment 62-D of FIG. 5 in such a manner that the nozzle pointed at the trajectory of a specified point of the intake/exhaust port 54/56P of the piston. The injector nozzle may be made pivotable about the axis Y-Y for better control of fuel injection timing.

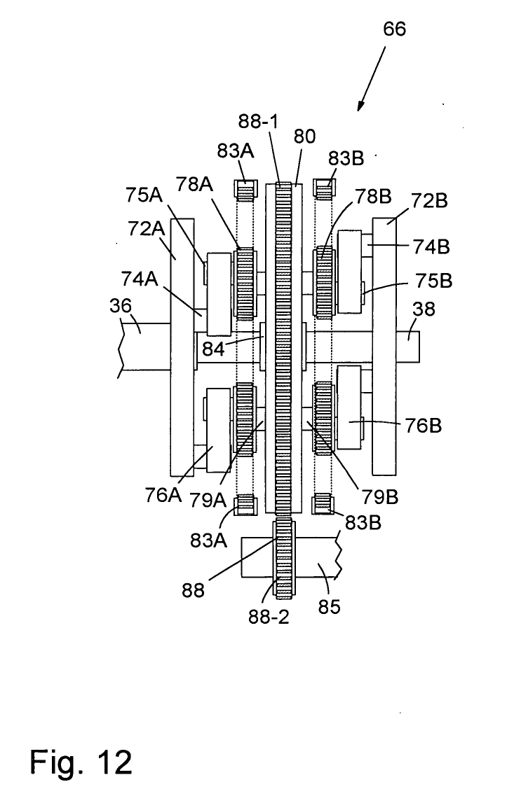

Connecting means, identified generally by reference numeral 66, for operatively interconnecting the first and second piston assemblies 30 and 32 to an engine output shaft 85 and for providing the piston assemblies with variable speed rotation, now will be described with reference to FIGS. 1, and 12. The connecting means 66 enclosed in a stationary connecting means housing includes a main transmission means 80, a pair of auxiliary transmission means 72A and 72B, and a pair of not-rotatable internal gears 83A and 83B that are affixed to the internal wall of the connecting means housing. The main transmission means 80 comprises a main gear set 88 and two parts A and B. Suffix A is used to identify connecting means elements in the A part, and suffix B is used to identify connecting means elements in the B part. The main gear set 88 comprises the main gear 88-1, which is mounted on an outer coaxial idler shaft 84 that is rotatably mounted on the inner piston shaft 38, and a pinion 88-2 (or the output gear) that is mounted on the output shaft 85.

The A part of the main transmission means 80 comprises a plurality of planetary gear and crank mechanisms. Each of which mechanisms comprises a planetary gear 78A, a connecting rod 76A, a piston pin 74A, and a crank pin 75A. The planetary gear 78A is mounted on a gear shaft 79A, which in turn is mounted on the hub of a main gear 88-1, and meshes with the internal gear 83A. One end of the connecting rod 76A is pivotably mounted on the piston pin 74A that is rotatably mounted on the auxiliary transmission means 72A, and the other end of the connecting rod 76A is pivotably mounted on the crank pin 75A that is rotatably mounted on the gear 78A on the opposite side from the hub of the main gear 88-1 in such a manner that the axis of the crank pin 75A will be apart from the axis of the gear shaft 79A by a predefined amount. The distance between the axis of the crank pin 75A and the axis of the gear shaft 79A is the crank arm length. The auxiliary transmission means 72A is affixed to the outer piston shaft 36. The number of planetary gears 78A is the same as the number of pistons 30A in the preferred embodiment.

In the eight-piston engine, the radius of the planetary gear 78A is one fourth of the radius of the internal gear 83A, and the radius of the output gear 88-2 is one fourth of the radius of the main gear 88-1. Thus, for one full revolution of the piston assembly 30 (or 32), the main gear 88-1 rotates one full revolution, and the output gear 88-2 rotates four full revolutions. In the four-piston engine, the radius of the planetary gear 78A is one half of the radius of the internal gear 83A, and the radius of the output gear 88-2 is one half of the radius of the main gear 88-1. Thus, for one full revolution of the piston assembly 30 (or 32), the main gear 88-1 rotates one full revolution, and the output gear 88-2 rotates two full revolutions.

The B part is generally identical to the A part, and thus its detailed description should not be necessary. In the B part, the crank mechanisms are mounted in the reverse direction of each other (though the two parts operationally travel in the same direction); the auxiliary transmission means 72B is affixed to the inner piston shaft 38; and the gear shaft 79A of the planetary gear 78A and the gear shaft 79B of the planetary gear 78B of the B part are extension of each other.

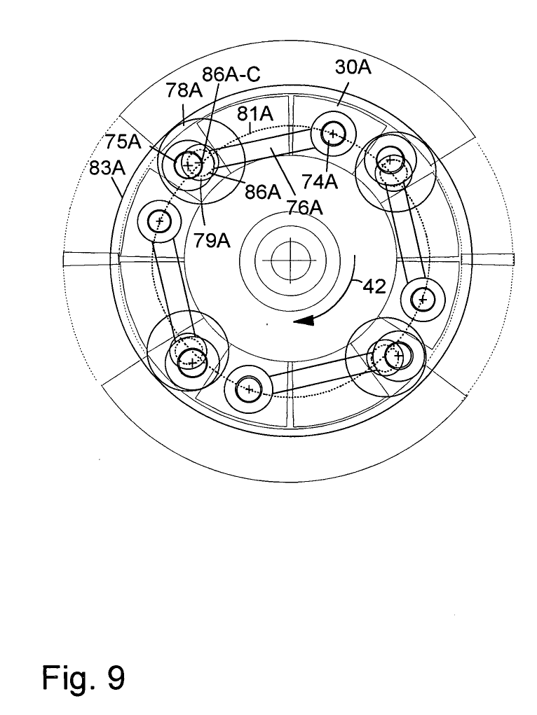

FIG. 9 shows the state of the internal gear-planetary gear and crank mechanism of the A part of the eight-piston engine at the time point at which each working chamber of the engine has just completed an engine phase and just about to start a new engine phase. For the illustration purpose, the pistons are shown in a simplified form using fine lines in these figures, wherein the leading piston surface in the simplified piston in FIG. 9 represents the piston surface (shown by A in FIG. 5) of the piston, and the trailing piston surface in the simplified piston represents the internal flat surface of the piston vessel (shown by B in FIG. 5).

As is shown in FIG. 9, the axis of the gear shaft 79A of the planetary gear 78A forms a circular trajectory 81A, and the axis of the crank pin 75A forms a circular trajectory 86A. The center 86A-C of the circular trajectory 86A is also the center of the gear shaft 79A, and moves along the circular trajectory 81A. The axis of the piston pin 74A, which is shown to be located at the mid-point of the superimposed leading piston for the illustration purpose, is located on the circular trajectory 81A of the axis of the gear shaft 79A. The main gear 88-1 rotates in the direction shown by the arrow 42, and the planetary gear 78A that meshes with the internal gear 83A rotates in the opposite direction.

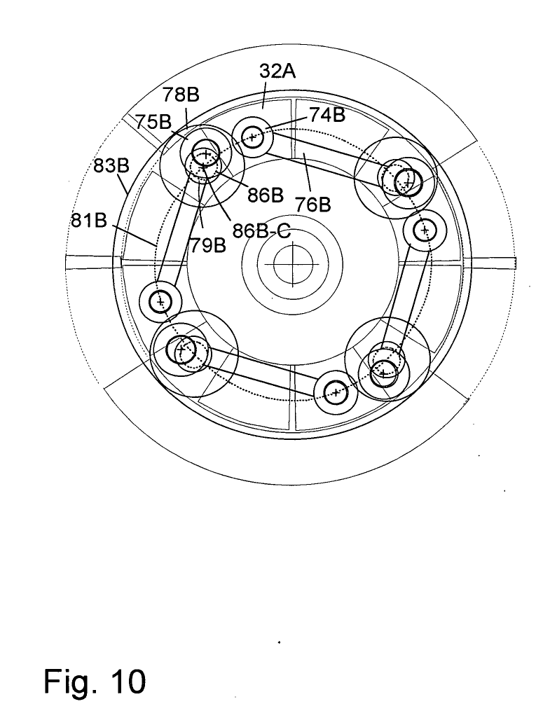

FIG. 10 illustrates the internal gear-planetary gear and crank mechanism of the B part taken at the same time point as the A part illustrated in FIG. 9. On the B part of the main transmission means 80, the axis of the gear shaft 79B forms a circular trajectory 81B; the axis of the crank pin 75B forms a circular trajectory 86B; and the center 86B-C of which circular trajectory is also the axis of the gear shaft 79B moves along the circular trajectory 81B. Similarly to that is done for the A part, for the illustration purpose, the axis of the piston pin 74B is located at the mid-point of a superimposed trailing piston on the circular trajectory 81B of the axis of the gear shaft 79B.

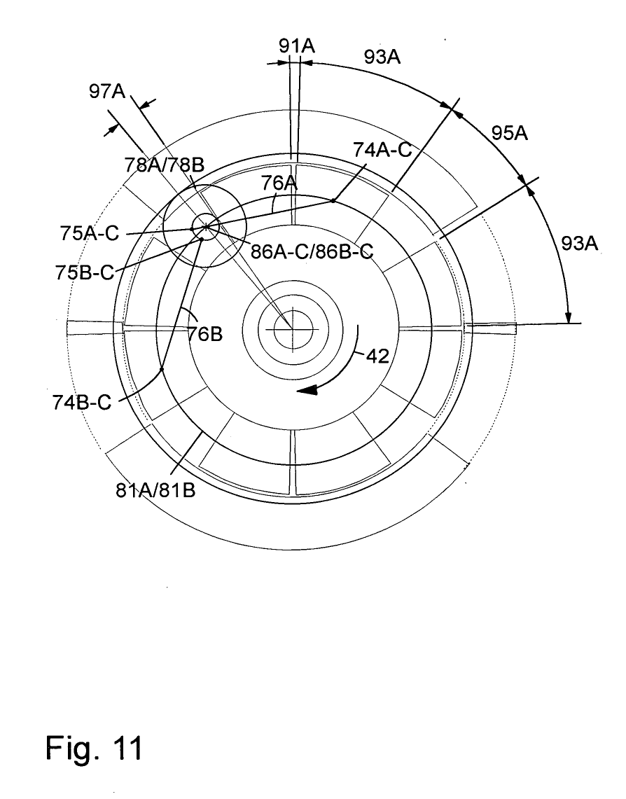

Reference is now made to FIG. 11, wherein the superimposed simplified schematics of the gear and crank mechanisms of the A and B parts are shown. The crank mechanism of the leading piston assembly that include the connecting rod 76A, the axis 75A-C of the crank pin 75A, the axis 74A-C of the piston pin 74A indicates that the leading piston is at the BDC, and the crank mechanism of the trailing piston assembly that include the connecting rod 76B, the axis 75B-C of the crank pin 75B, the axis 74B-C of the piston pin 74B indicates that the trailing piston is at the TDC.

The connecting means that is equipped with only one of the internal gear-planetary gear sets; i.e., either internal gear 83A and the planetary gears 78A, or the internal gear 83B and the planetary gears 78B, is an alternative embodiment of the connecting means. Another alternative design of the main transmission means, in which the crank mechanisms in the A part and the B part are mounted in the same direction and the planetary gears 78A and 78B share the same gear shafts, should have the same effect as the main transmission means 80 described in the preferred embodiment. Yet another alternative design of the main transmission means, in which the planetary gears 78A and 78B do not share the same gear shaft is possible, but is not as desirable.

Dimensions of key design elements of the piston assembly and the crank mechanism are expressed in radians as the center angles and given as:

Cₘₐₓ=8(α+α/c)/Nₚ, (1)

Cₘᵢₙ=8(α/c)/Nₚ, (2)

P_{w}=4(π/2−α−α/c)/Nₚ, and (3)

r_{c}=α/2. (4)

wherein
Cₘₐₓ=maximum working chamber width (rad), shown as 95A in FIG. 11,
Cₘᵢₙ=minimum working chamber width (rad), shown as 91A in FIG. 11,
P_{w}=piston width (rad), shown as 93A in FIG. 11,
r_{c}=crank arm length (rad) between 75A-C and 86-C (and 75B-C and 86A-C in FIG. 11, shown as 97A in FIG. 11
α=a coefficient (between 0 and 1) that shows the minimum and maximum rotational speeds of the piston assemblies 30 and 32 relative to the mean rotational speed ω₀ of the two piston assemblies, wherein the rotational speeds of which piston assemblies follow a sine curve, and their maximum rotational speed is given as (1+α)ω₀ and the minimum rotational speed is given as (1−α)ω₀. The α value may be selected arbitrarily. The simplified piston assembly geometry shown in FIGS. 9 through 11 reflects the α value of 0.4.

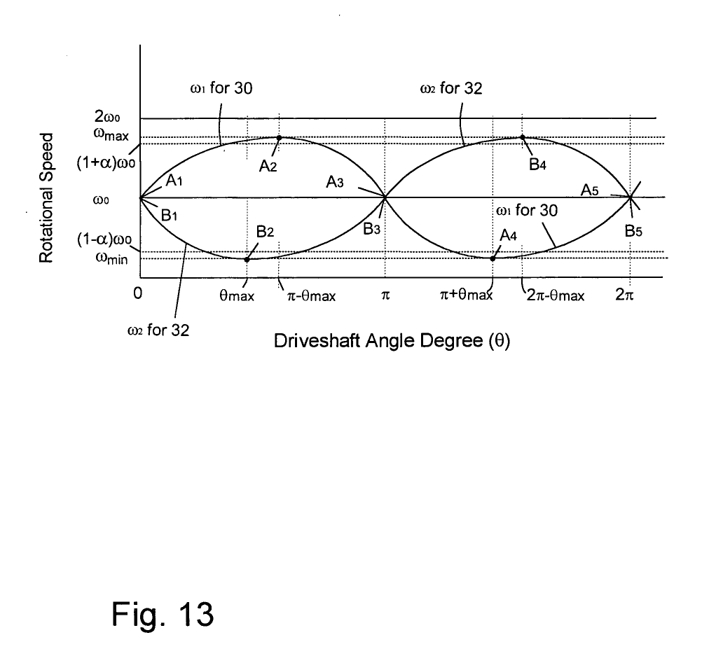

As is shown in FIG. 13, the rotational speeds of the piston assemblies 30 and 32 are both ω₀ at DAD (driveshaft angle degree) θ=0, wherein the axis of the crank pin 75A-C is located at the BDC and the axis of the crank pin 75B-C is located at the TDC (see FIG. 11). The relative rotational speed vₚₗ(θ) of the leading piston assembly to the mean rotational speed of the piston assemblies 30 and 32 as a function of θ is expressed generally as:

vₚₗ(θ)=1+α[ sin θ−(sin 2θ)/(2λ)], (5)

and, the relative rotational speed vₚₜ(θ) of the trailing piston assembly to the mean rotational speed of the piston assemblies 30 and 32 as a function of θ is expressed generally as:

vₚₜ(θ)=1−α[sin θ+(sin 2θ)/(2λ)], (6)

where
θ=driveshaft angle degree (DAD), and
λ=connecting rod length/crank arm length.

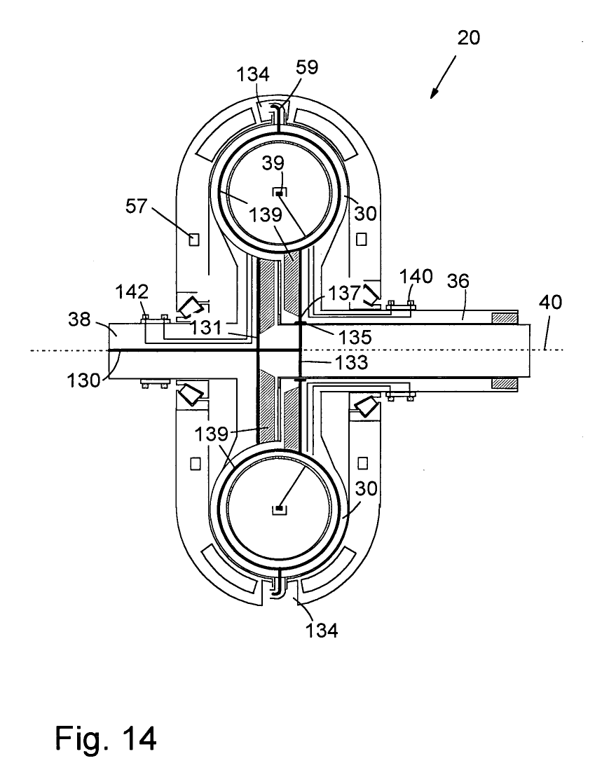

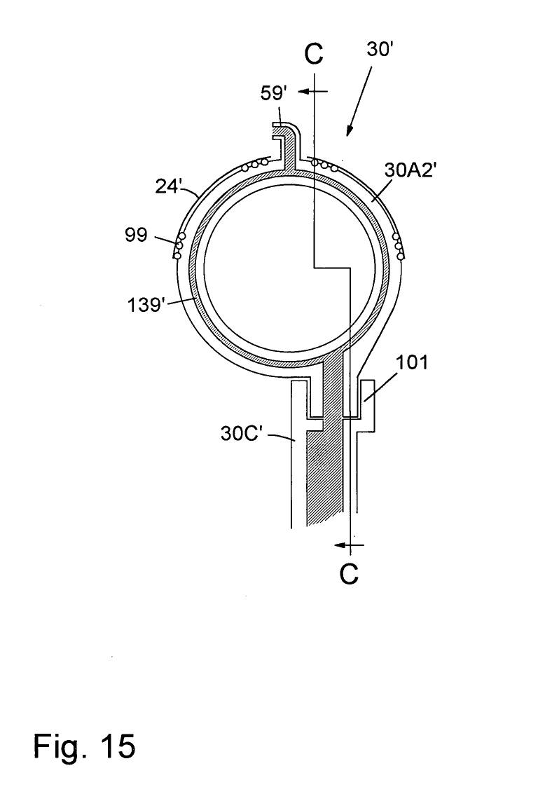

Reference is now made to FIG. 14 of the drawings, wherein a cooling and lubrication oil delivery/recycling system and a wiring system of a working chamber assembly of the spark ignition engine is shown. The oil delivery system comprises oil bores 130, 131, 133, 137, which are shown by thick real lines, oil outlet 59, oil gutters 134 and 57, an oil pump (not shown), and an oil pan (not shown). Oil is pumped into the working chamber through the oil bore 130, which extends along the rotational axis 40 of the inner piston shaft 38.

The cooling and lubrication oil carried by the bore 130 is diverted into radially extending bores 131, and 133. The oil bore 131 delivers oil to the internal cavity of the hollow piston assembly 32, and the oil bore 133 delivers oil to the internal cavity 139 of the hollow piston assembly 30 via a depression 135 on the internal wall of the tubular piston shaft 36, and the oil bore 137. Lubrication of the piston rings is done by the oil overflowed from the internal depression 135. The oil that circulated through the piston assemblies 30 and 32 shoots out from the oil outlet 59 into the oil gutter 134 that extends along an imaginary line that is made up of the outermost points of the internal wall of the working chamber assembly housing, and is recycled back to the oil pan and oil pump. The oil seeped into the intake and exhaust ports is sent back to the oil pan through the oil gutter 57.

In the SI engine, a spark plug 39 is embedded in the inside cavity of the piston heads 30A1 and 32A1. A power terminal 140 is affixed to the external wall of the tubular shaft 36, and another power terminal 142 is affixed to the external wall of the inner shaft 38.

The spark plugs in the piston heads 30A1 cavities are connected to the power terminal 140, and the spark plugs in the piston heads 32A1 cavities are connected to the power terminal 142.

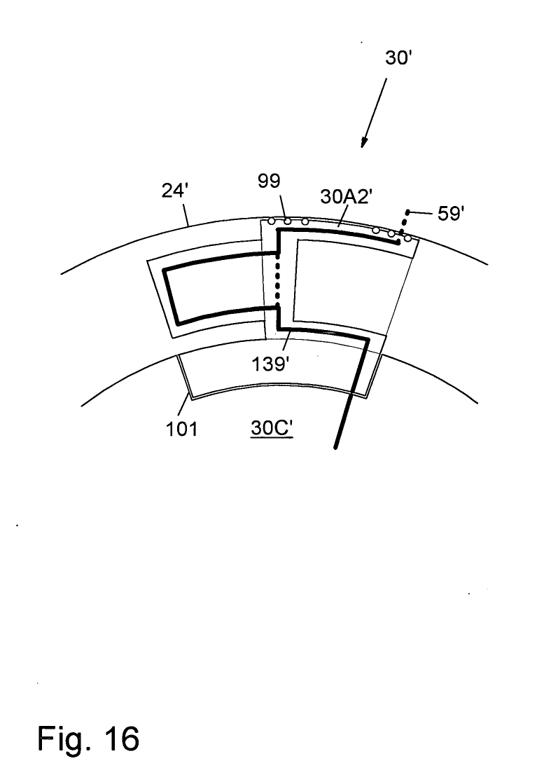

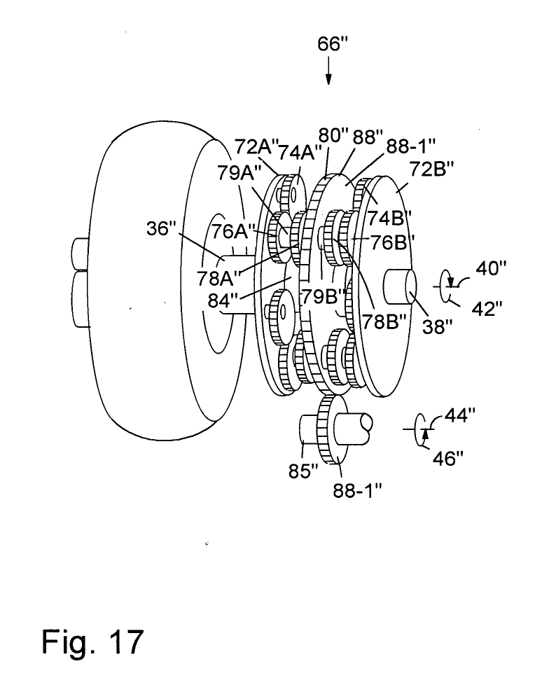

Reference is now made to FIGS. 15 and 16, wherein an alternative embodiment of piston assembly 30′, which is generally identical to the alternative embodiment of piston assembly 32′, is shown. In this alternative embodiment, the piston 30A1′ is snapped into a socket of the piston hub 30C′. In operation, the piston 30A1′ is held in place by the socket 101 and ball bearings 99 that roll along the internal wall 24′ of the working chamber assembly housing. The cooling and lubrication oil travels through the internal cavity of the piston hub 30C′ to the internal cavity 139′ of the piston 30A1′, and flows out from the oil outlet 59′.

Reference is now made to FIG. 17, wherein an alternative embodiment of the connecting means 66″ that uses noncircular gear sets is shown. The connecting means uses the noncircular gear set that comprises first and second noncircular gears in place of the crank mechanisms as the means for transmitting variable rotation. The connecting means 66″ includes a main transmission means 80″, a pair of auxiliary transmission means 72A″ and 72B″, and a pair of not-rotatable internal gears 83A″ and 83B″ (not shown) that are affixed to the internal wall of a stationary connecting means housing. The main transmission means 80″ comprises a main gear set 88″ and generally identical two parts A and B.

The A part of the main transmission means 8″ comprises a plurality of planetary gears 78A″ and second noncircular gears 76A″. The planetary gears 78A″ is rotatably mounted on a gear shaft 79A″ and meshes with the internal gears 83A″ that is mounted on the internal wall of the working chamber assembly housing 22″. The first noncircular gear 74A″ is rotatably mounted on the auxiliary transmission means 72A″ and meshes with the second noncircular gear 76A″ that is mounted on the gear shaft 79A″ of the planetary gear 78A″. The auxiliary transmission means 72A″ is affixed to the outer piston shaft 36″, and the auxiliary transmission means 72B″ is affixed to the inner piston shaft 38.

An alternative embodiment of the connecting means 66″ uses the Sakita gears as defined by Equations (1) through (5) in U.S. Pat. No. 6,457,451 by Sakita. In the connecting means, the type 1 gear 74A″ meshes with the type 2 gear 76A″, and the type 1 gear 74A″ is rotatably affixed to the auxiliary transmission means 72A″, and the type 2 gear 76A″ is mounted on the gear shaft 79A″. A special case of the Sakita gears uses asymmetric type 1 and type 2 gears that have zero-length arc segments, and that satisfy the condition set by the aforementioned Equations (1) through (5), wherein Equation (1) states that sum of the rotational speeds of the faster rotating type 1 and the slower rotating type 1 gear is twice the rotational speed of the type 2 gear, and Equations (2) through (5) define the radius Y₁ of the type 1 gear and the radius X₁ of the type 2 gears at which the maximum rotational speed of the type 1 occurs, and the radius Y₂ of the type 1 gear and the radius X₂ of the type 2 gears at which the minimum speed of the type 1 gear as shown in FIG. 16. The type 1 gear 74A″ is identical to 74B″, and the type 2 gear 76A″ is identical to 76B″. Thus, description of only the type 1 and 2 gears 74A″ and 76A″ should suffice.

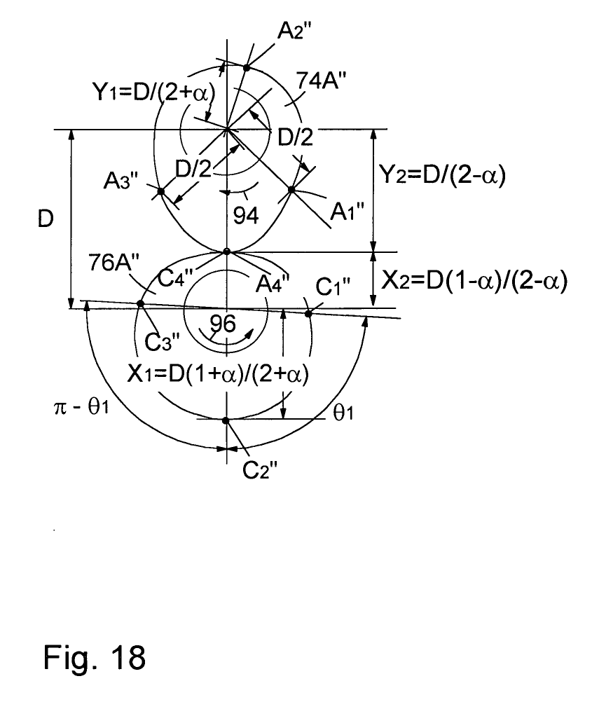

As is shown in FIG. 18, the distance between the rotational axis of the type 1 gear 74A″ and the rotational axis of the type 2 gear 76A″ is D. The point A₁″ of the type 1 gear meshes with point C₁″ of the type 2 gear. At A₁″, the rotational speed of the type 1 gear 74A″ equals the rotational speed of the type 2 gear 76A″. The point A₂″ of the type 1 gear meshes with point C₂″ of the type 2 gear. At A₂″, the type 1 gear 74A″ has the maximum speed. The point A₃″ of the type 1 gear meshes with C₃″ of the type 2 gear. At A₂″, the rotational speed of the type 1 gear 74A″ equals the rotational speed of the type 2 gear 76A″. The point A₄″ of the type 1 gear meshes with the C₄″ of the type 2 gear. AT A₄″, the type 1 gear 74A″ has the minimum speed. The type 1 gear 74A″ has the minimum radius at A₂″, and the maximum radius at A₄″. The type 2 gear 76A″ has the maximum radius at C₂″, and the minimum radius at C₄″. The direction of rotation of the type 1 gear is shown by an arrow 94, and the direction of rotation of the type 2 gear is shown by an arrow 96.

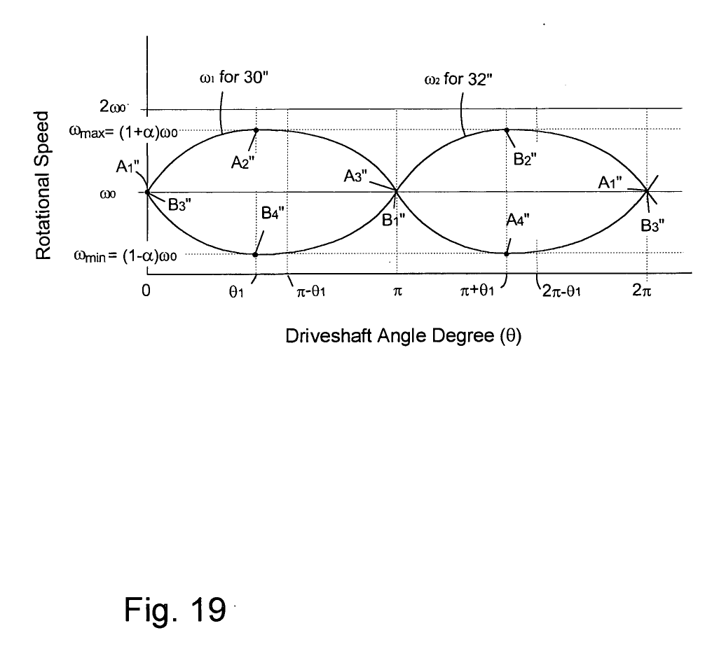

As is shown in FIG. 19, the type 1 gear 74A″ has the maximum rotational speed of (1+α)ω₀ at θ=θ₁, and π+θ₁. The type 1 gear 74B″ has the minimum rotational speed of (1+α)ω₀ at θ=θ₁, and π+θ₁. Note that θ₁<π. In the alternative embodiment, the α is a coefficient (between 0 and 1) that shows the minimum and maximum rotational speeds of the piston assemblies relative to the mean rotational speed ω₀ of the two piston assemblies without specifying any specific rotational speed functions. Just as in the case with the symmetric noncircular gears, the a also indicates the sharpness (or roundness) of the noncircular gears. The curvature of the noncircular gears along the pitch circles will be adjusted in such a manner that the derivative of the rotational speed function for the type 1 gear 74A″ (and 74B″) on the left side of π will equal to the derivative of the rotational speed function of the right side.

The rotational speed function of which asymmetric noncircular type 1 gear 74A″ (and 74B″) follows a piecemeal sinusoidal and modified sinusoidal functions. The engine with such a connecting means will generate torque due to gas force as a function of θ, T_{q}(θ), such that:

T_{q}(θ)=F_{g}(θ)R_{A}α[ sin(θπ/2θ₁)+δ₁₀₇ (θ)cos [θ−θ₁)π/(π−θ₁)], (8)

where F_{g}(θ) is force due to gas pressure; R_{A} is arm length of the piston assemblies 30″ and 32″; and δ₁₀₇ is a fudge variable enabling a smooth variation of the varying radius of the gear at θ=π, such that the derivative of the rotational speed function on the left side of π will equal to the derivative of the rotational speed function of the right side of π, and expressed for example as:

δ₁₀₇ (θ)=(π−2θ₁)/[(π−θ₁)θ₁]θ−(π−2θ₁)/[(π−θ₁)θ₁]θ₁+1. (9)

Derivation of the relationship between the rotational angle and the variable radius of the gears is straightforward and should not be necessary.

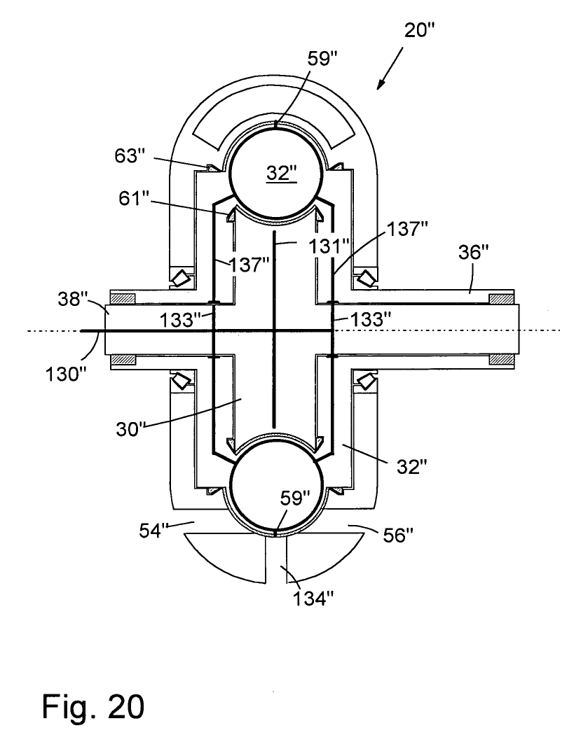

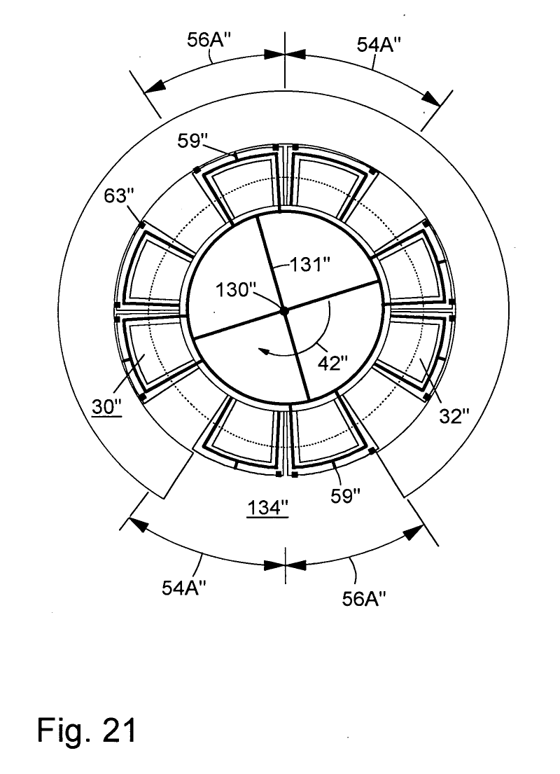

Reference is now made to FIGS. 20 and 21 of the drawings, wherein an alternative embodiment of the working chamber assembly with a cooling and lubrication oil delivery/recycling system is shown. The working chamber assembly of the alternative embodiment includes a pair of rotational piston assemblies 30″ and 32″, housed in a working chamber assembly housing 22″. In this alternative embodiment, a toroidal working chamber, which is formed by the internal wall of the working chamber assembly housing, piston surfaces, and piston hubs, is divided into a plurality of subchambers by the pistons. The piston assembly 30″ is affixed to the inner piston shaft 38″, and a piston assembly 32″ is affixed to the outer piston shaft 36″. The working chamber is sealed by inner chamber rings 61 ″, outer chamber rings 63″, and piston rings 65″. The oil delivery system includes oil bores 130″ and 133″, and internal cavities of the piston assemblies 131″ and 137″, which are shown by thick real lines, oil outlet 59″, oil gutter 134″, an oil pump (not shown), and an oil pan (not shown). Oil is pumped into the working chamber through the oil bore 130″, which extends along the rotational axis 40″ of the inner piston shaft 38″.

Lubrication of the inner chamber rings will be done by spilled cooling oil from the oil bore 133″. Lubrication of the outer chamber rings is done by oil that is delivered by a narrow bore (not shown) diverted from the internal cavity 137″ of the piston assembly 32″. Lubrication of piston rings is done by oil that is delivered by a narrow bore (not shown) diverted from the internal cavity 131″ of the piston assembly 30″.

The oil outlet 59″ located at the outer most part of the piston with an oil outlet ring laid in a groove encircling it, and the oil outlet ring is continuously pressed against the internal wall of the working chamber by a spring embedded in the back clearance of the groove. The working chamber assembly housing has an intake port 54A″ and an exhaust port 56A″ on the opposite sides of the working chamber, and they are located longitudinally next to each other in the direction of rotational movements of the pistons. The internal wall of the working chamber assembly housing has an oil gutter 134″ in parallel to the intake and exhaust ports generally at the bottom of the working chamber. In operation, the cooling oil that circulated through the internal cavities of the piston assemblies 30″ and 32″ shoots out from the oil outlet 59″ to the oil gutter 134″, and is recycled back to the oil pan and oil pump (not shown).

The invention having been described in detail in accordance with the requirements of the U.S. Patent Statutes, various other changes and modification will suggest themselves to those skilled in this art. For example, the number of pistons attached to a piston assembly may not be limited to two or four. Similarly, the number of the planetary gears may be as many or as few as practicable. The connecting means may use sprockets and chains instead of the circular main gear set. It is intended that the above and other such changes and modifications shall fall within the spirit and scope of the invention defined in the appended claims.

I claim:

1. An internal combustion engine comprising
a working chamber assembly including first and second piston assemblies each of which assemblies having at least one pair of diametrically opposed pistons rotatable about a rotational axis of said piston assemblies,
means for interconnecting said first and second piston assemblies for variable-speed rotation in same direction during recurrent periods of rotation,
a working chamber assembly housing, connecting means housing, and a cooling and lubrication means, wherein
said piston having a piston head and a piston vessel,
said piston head of said first piston assembly received by said piston vessel of said second piton assembly and said piston head and said piston vessel together form a working chamber,
said piston head of said second piston assembly received by said piston vessel of said first piton assembly and said piston head and said piston vessel together form a working chamber,
at least one pair of diametrically opposed working chambers decreases in volume while at least one other pair of diametrically opposed working chambers increases in volume, and
for each complete revolution of said first and second piston assemblies at least one operating cycles is completed, each operating cycle includes successive intake, compression, combustion, and exhaust phases.

2. An internal combustion engine as defined in claim 1 wherein
said working chamber assembly housing includes an intake port and an exhaust port,
said piston includes a port that is aligned with said intake port of said working chamber assembly housing.

3. An internal combustion engine as defined in claim 1 wherein
said working chamber assembly housing includes an intake port and an exhaust port,
said piston includes a port that is aligned with said exhaust port of said working chamber assembly housing.

4. An internal combustion engine as defined in claim 1 wherein said working chamber assembly housing includes a fuel injector wherein
said fuel injector is capable of adjusting fuel injection time.

5. An internal combustion engine as defined in claim 1 wherein
said means for interconnecting said first and second piston assemblies comprises a main transmission means, first and second auxiliary transmission means, and first and second internal gears affixed to the internal wall of a connecting means housing, wherein said main transmission means comprises generally identical first and second parts, and a main gear set,
each of said parts includes a plurality of means for variably transmitting rotational force,
first auxiliary transmission means includes a means to rotatably connect said main transmission means and first piston assembly, and
second auxiliary transmission means includes a means to rotatably connect said main transmission means and second piston assembly.

6. An internal combustion engine as defined in claim 1 wherein
said piston has an oil outlet at its outermost part through which used cooling oil is exhausted.

7. An internal combustion engine as defined in claim 1 wherein
said working chamber assembly housing having an internal wall, and
said cooling and lubrication means includes an oil gutter that extends along an imaginary line that is made up of outermost points of said internal wall of said working chamber assembly housing.

8. An internal combustion engine comprising
a working chamber assembly including first and second piston assemblies each of which assemblies having at least one pair of diametrically opposed pistons rotatable about a rotational axis of said piston assemblies,
means for interconnecting said first and second piston assemblies for variable-speed rotation in same direction during recurrent periods of rotation,
a working chamber assembly housing, connecting means housing, and a cooling and lubrication means, wherein
said first and second piston assemblies including said pistons having internal cavities,
said piston includes an oil outlet located at outermost part,
said working chamber assembly housing includes an oil gutter for exhausting used cooling oil, and
in operation, cooling oil that circulated through said internal cavities of said piston assemblies shoots out from said oil outlet to said oil gutter.

9. An internal combustion engine as defined in claim 8, wherein
said working chamber assembly housing having an internal wall, and
said cooling and lubrication means includes an oil gutter that extends along an imaginary line that is made up of outermost points of said internal wall of said working chamber assembly housing.

10. An internal combustion engine as defined in claim 8, wherein
said working chamber assembly housing having an intake port and an exhaust port,
said oil outlet includes an oil outlet ring,
said oil outlet ring always pressed against said inner wall of said working chamber assembly housing,
said oil gutter is located in parallel to said intake port and said exhaust port generally at the bottom of the engine.

11. An internal combustion engine comprising
a working chamber assembly including first and second piston assemblies each of which assemblies having at least one pair of diametrically opposed pistons rotatable about a rotational axis of said piston assemblies,
means for interconnecting said first and second piston assemblies for variable-speed rotation in same direction during recurrent periods of rotation,
a working chamber assembly housing, connecting means housing, and a cooling and lubrication means, wherein
said connecting means housing having an internal wall,
at least one internal gear affixed to said internal wall,
said means for interconnecting said first and second piston assemblies comprises a main transmission means, and first and second auxiliary transmission means,
said main transmission means comprises a main gear set, and first and second parts,
said first and second parts include a plurality of means for transmitting variable speed rotation,
at least one of said parts includes a plurality of planetary gears,
said internal gear meshes with said planetary gears,
said first piston assembly affixed to an outer piston shaft,
said second piston assembly affixed to an inner piston shaft,
first auxiliary transmission means affixed to said outer piston shaft, and
second auxiliary transmission means affixed to said second piston shaft.

12. An internal combustion engine as defined in claim 11 wherein
said main gear set comprises a main gear and an output gear,
said main gear having a hub, and
said planetary gear mounted on a shaft that is rotatably attached to said hub of said main gear.

13. An internal combustion engine as defined in claim 11 wherein
said means for transmitting variable speed rotation includes a piston pin, a crank pin, and a connecting rod,
one end of said connecting rod is pivotably mounted on a piston pin, which is rotatably mounted on said auxiliary transmission means, and
the other end of said connecting rod is pivotably mounted on a crank pin that is rotatably mounted on a side of said planetary gear.

14. An internal combustion engine as defined in claim 11 wherein
said means for transmitting variable speed rotation includes a noncircular gear set,
said noncircular gear set includes first and second noncircular gears,
said first gear of said noncircular gear set mounted on a first gear shaft,
said first gear shaft of said noncircular gear rotatably mounted on said auxiliary transmission means, and
said second gear of said noncircular gear set mounted on gear shaft of said planetary gear.

15. An internal combustion engine as defined in claim 14 wherein
said noncircular gear set is the Sakita gear set.
